(19) United States
(12) Patent Application Publication
(10) Pub. No.: US 2005/0064777 A1
(43) Pub. Date: Mar. 24, 2005

(54) Composite foam backed fabric

(76) Inventor: Bruce Stewart, Lancs (GB)

Correspondence Address: MILLIKEN & COMPANY, 920 MILLIKEN RD (M-495), PO BOX 1926, SPARTANBURG, SC, 29304, US

(21) Appl. No.: 10/492,037

(22) PCT Filed: Oct. 11, 2002
(86) PCT No.: PCT/EP02/11430

(30) Foreign Application Priority Data
Oct. 12, 2001 (GB) 0124507.5

(51) Int. Cl. B32B 3/26; B32B 17/02

(52) U.S. Cl. 442/22; 428/304.4; 442/221; 442/315

(57) ABSTRACT

This invention relates to composite foam backed fabrics, particularly to such fabrics which are suitable for use in automobiles A composite layered fabric structure is provided which comprises a surface layer of knitted or woven face fabric, an intermediate foam layer attached to the surface layer, and a scrim layer attached to the foam surface remote from the face fabric, wherein the scrim comprises a non-woven and the composite is able to be resiliently stretched more than 5% in both longitudinal and transverse directions under a load of 10 kg.

### TECHNICAL FIELD

This invention relates to composite foam backed fabrics, particularly to such fabrics which are suitable for use in automobiles and most particularly to fabrics wherein the foam is protected by a scrim layer applied to the face remote from the fabric face.

### BACKGROUND TO THE INVENTION

Automotive fabrics are usually knitted or woven and may have a pattern to fit the general design and decor of the automobile. Normally the fabric is mounted on a foam backing and the resulting composite is further mounted on a scrim which can improve the dimensional stability of the composite and which, more importantly protects the otherwise exposed surface of the foam and allows the fabric to be more easily handled when it is being cut and sewn to fit around the shape of a seat and the like.

Traditionally woven or knitted scrims have been used for such applications. They suffer from the disadvantages that any defect in the scrim results in that portion of the composite having to be rejected which increases the manufacturing cost. It is known to apply a flame retardant to knitted scrims.

### DISCLOSURE OF INVENTION

According to the present invention there is provided a composite layered fabric structure comprising a surface layer of knitted or woven face fabric, an intermediate foam layer attached to the surface layer, and a scrim layer attached to the foam surface remote from the face fabric, wherein the scrim comprises a non-woven and the composite is able to be resiliently stretched more than 5%, preferably more than 6 to 15%, particularly preferably more than 7% to 10% in both longitudinal and transverse directions under a load of 10 kg. When stretched accordingly, the scrim does not tear. Composites showing this stretching ability can generally be stretched by hand more than 5% in both longitudinal and transverse directions.

The knitted or woven fabric is preferably a polyester fabric, most preferably a polyester jacquard. Its preferred weight is in the range of 150 to 300 g/m². The fabric should be able to be resiliently stretched more than 5% in both longitudinal and transverse directions under a load of 10 kg.

The foam layer is preferably composed of polyester. Its preferred thickness is in the range 2 mm to 7 mm. The foam layer has an elasticity and stretching ability which is significantly larger than that of the fabric and the scrim layer.

The scrim preferably consists of a non-woven, most preferably a polyester non-woven. Other usable scrims include nylon scrims. The elasticity of the scrim is generally larger than that of the fabric, preferably by at least 10%. Preferred scrims have a stretching ability of more than 10% in lengthwise direction, more preferred are those having a stretching ability of more than 15% to 35% in lengthwise direction. The weight may be in the range 25 gm⁻² to 70 gm⁻², preferably about 30 gm⁻². By about 30 g it is intended to indicate a range of 27-33 g. The use of a low weight scrim such as about 30 gm⁻² may aid the overall elasticity of the composite. The scrim does not tear when the composite of the present invention is stretched 5%, preferably 10%, more preferably up to 15%.

The scrim is desirably made from polyester that is flame retardant sufficiently for the composite to pass ISO3795 FMVSS302. Advantageously the scrim has a burn rate of less than 80 mm measured by that test.

The composite layer fabric structure is preferably produced by flame-laminating the three layers.

A particular advantage of this invention is the ability to manufacture self-extinguishing thin composite laminates. A further advantage of incorporating flame retarding properties into the scrim is that it is more cost effective way to achieve the required performance than the application of a flame retardant by other means, for example by applying it to the face fabric.

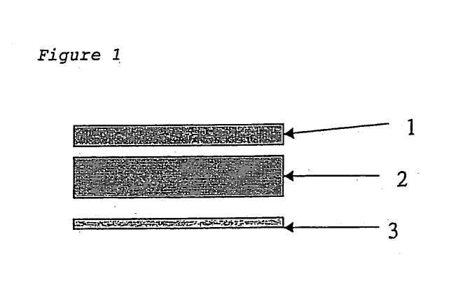

The invention will now be further described by way of example only and with reference to FIG. 1, which is an exploded cross-sectional representation of a composite structure according to the invention.

FIG. 1 shows a face fabric 1, which is a woven polyester seat covering fabric. This fabric is laminated to a layer of foam 2, which is a polyester foam of 3 mm thickness. In turn the foam is laminated to a polyester non-woven scrim of 30 g per m² weight which has been fabricated to make it flame retardant. The resulting composite laminated structure is sufficiently elastic to be cut and sewn into a seat cover which fits well over the seat and furthermore has excellent flame retarding properties whilst also achieving a higher productivity due to the use of the non-woven scrim with lower fault incidence than traditional woven or knitted scrims.

### EXAMPLES

Different fabrics were flame-laminated to a layer of polyester foam of 3 mm thickness which in turn was flame-laminated to a polyester non-woven scrim of 30 g per m² weight which has been fabricated to make it flame retardant. The elongation (stretch) of the composite was determined as follows:

The test method defines a procedure for determining elongation under constant load conditions. Two grips capable of accommodating the width of the test specimen. One grip shall be capable of being attached to a rigid support so that when the test specimen is inserted centrally, it hangs in a vertical plane. The other grip shall be constructed so that dead loads may be added to bring it to the required total weight (e.g. 10 kg). The test comprises the following steps:
1. Prepare test specimen to appropriate sample size (e.g. 450×50 mm).
2. Draw two lines across each specimen at right angles to the longest dimension and equally distanced inboard from each end to gauge lengths.
3. Insert the specimen centrally to the fixed grip. Insert the other end of the specimen similarly in the loose grip.
4. Apply the required load to bring the mass including the loose grip to the total load.
5. Allow the appropriate minutes (generally 10 min) to elapse, then measure and record to the nearest 0.5 mm the distance between the lines.
6. Calculate the elongation for each specimen. The elongation is expressed as a percentage.

The following results were obtained:

| Fabric | Length | Width | Sample type |
|---|---|---|---|
| A | 7% | 5% | Sample size 450 × 50 mm. Load 10 kg. 10 |
| | | | min. |
| | | | Fabric Type Polyester Dobby. 290 g/m² |
| B | 7.5% | 5.5% | Sample size 450 × 50 mm. Load 10 kg. 10 |
| | | | min. |
| | | | Fabric Type Polyester Dobby. 285 g/m² |
| C | 5.5% | 6% | Sample size 80 × 250 mm. Load 10 kg. 10 |
| | | | min. |
| | | | Fabric Type Polyestert Jacquard. 184 g/m² |
| D | 6% | 5% | Sample size 80 × 250 mm. Load 10 kg. 10 |
| | | | min. |
| | | | Fabric Type Polyester Jacquard. 250 g/m² |
| E | 7.9% | 7.5% | Sample size 450 × 50 mm. Load 10 kg. 10 |
| | | | min. |
| | | | Fabric Type Polyester Jacquard. 245 g/m² |
| F | 6.7% | 5.7% | Sample size 450 × 50 mm. Load 10 kg. 10 |
| | | | min. |
| | | | Fabric Type Polyester Jacquard. 265 g/m² |

1. A composite layered fabric structure comprising a surface layer of knitted of woven face fabric, an intermediate foam layer attached to the surface layer, and a scrim layer attached to the foam surface remote from the face fabric, wherein the scrim comprises a non-woven and has a weight in the range of 25 to 75 gm⁻² and wherein the composite is able to be resiliently stretched more than 5% in both longitudinal and transverse directions under a load of 10 kg.

2. A composite according to claim 1, wherein the composite is able to be resiliently stretched more than 7% in both longitudinal and transverse directions under a load of 10 kg without the scrim being subject to tear.

3. A composite according to any preceding claim in which the scrim is about 30 gm⁻² weight.

4. A composite according to any preceding claim in which the scrim is a polyester non-woven.

5. A composite according to any preceding claim in which the foam is polyester foam.

6. A composite according to any preceding claim in which the surface layer is polyester woven or knitted fabric.

7. A composite according to any preceding claim in which the scrim is selected from scrims that give a flame retardancy to the composite of less than 80 mm as defined in ISO3795 FMVSS302.

8. A composite according to claim 7 in which the scrim is selected from scrims which give a self-extinguishing composite.
